(19) United States
(12) Patent Application Publication
(10) Pub. No.: US 2024/0250619 A1
(43) Pub. Date: Jul. 25, 2024

(54) Motionless high frequency magnetic method and apparatus to extract potential from DC batteries without destroying the battery's charge

(71) Applicant: Victor M. Villalobos, Huachuca City, AZ (US)

(72) Inventor: Victor M. Villalobos, Huachuca City, AZ (US)

(21) Appl. No.: 18/016,939

(22) PCT Filed: Nov. 21, 2021
(86) PCT No.: PCT/US21/60230

§ 371 Date: Jan. 19, 2023

Related U.S. Application Data
(60) Provisional application No. 63/275,385, filed on Nov. 3, 2021.

(51) Int. Cl. H02M 11/00; H02J 7/00

(52) U.S. Cl. CPC H02M 11/00; H02J 7/00

(57) ABSTRACT

The patent discloses a method and apparatus to extract negative electromagnetic potential from DC sources as negative electromagnetic potential (magnetic energy) by borrowing but not consuming the positive potential of the DC sources without sacrificing the charge of the DC source while the produced electromagnetic potential can be used to do work without sacrificing the “battery's charge” thus maintaining the DC sources charged up.

### CROSS REFERENCE TO RELATED APPLICATIONS

USPTO Provisional Patent Ser. No. 63/275,385 filed on Nov. 3, 2021.

Foreign Filing License Granted US Granted. Nov. 9, 2021

### PREAMBLE OF THE INVENTION

Our society uses millions of DC batteries every day and, today is perfectly acceptable that DC batteries will be discharged as they are being used.

This patent offers a NEW ART which uses a novice method to use DC sources which allows the extraction of usable negative electromagnetic potential from the DC sources without sacrificing their charge in a manner which does not deplete the positive charge of the DC source and which does not discharge the battery as a source.

This patent discloses a method to extract negative electromagnetic potential from DC sources as negative electromagnetic potential (magnetic energy) by borrowing but not consuming the positive potential of the DC sources without sacrificing the charge of the DC source while producing electromagnetic energy which can be used to do negative work without sacrificing the “battery's charge” thus maintaining the DC sources charged up.

The NEW ART uses a method to generate a negative magnetic field and a negative electrical field separate using the negative potential from at least two separate DC sources using at least two separate electromagnetic oscillators residing in the 4^{th} Quadrant of power generation(FIG. 1).

Every battery when charged stores electrical energy potential in two separate compartments and parts, they are (a) an equal amount of positive potential and (b) an equal amount negative potential. When we charge a DC battery with positive potential, the universe provides an equal amount of negative electromagnetic potential to balance the battery and vice-versa, when we charge a DC battery with negative magnetic potential, the universe produces an equal amount of positive electromagnetic potential to balance the battery.

This also applies when we discharge a battery.

Thus, a charged battery contains two equal separate charges: a positive potential energy charge and a negative potential energy charge, this is true for any battery, any capacitor, any supercapacitor or device that stores energy. All electrical potential in batteries is stored as two equal charges of positive and negative potential amounts which are continually balancing the chemistry of the battery when use the battery.

Our society has chosen to utilize primarily the positive potential of the DC sources to do electrical work which destroys the positive potential charge of the source by depleting both the positive and the negative charge. In contrast with the utilization of Negative potential to do negative work which increases the negative potential while replenishing the positive charge of the DC source. When we use negative charge potential to do negative work, the source balances by absorbing positive potential from the surroundings(Dirac theories) which replenishes the positive charge of the DC source.

This patent offers a NEW ART to harvest negative electromagnetic process-method and an apparatus which harvest electromagnetic potential without discharging the source by borrowing but not consuming the positive potential of the DC.

Negative potential, it is abundant, free, inexhaustible and thus when we do negative work with negative electromagnetic potential, we generate an equal amount of positive electromagnetic potential(Dirac's theory) which is returned to replenish the DC source.

Quoting from Quora about the origin of Negative energy:
“The hypothesis is that all the positive energy, kinetic (including heat and electromagnetic), positive potential energy (like charge repulsion) and mass itself (through mass energy equivalence) has been borrowed from attractive fields, leaving lots of negative potential energy behind in the form of future energy ion's
   Negative magnetic energy can be easily generated thru the oscillation of inductors at high frequency, it is amplifiable and can be converted back to Positive energy without a bit of pollution.

As demonstrated by this patent, Negative electromagnetic potential can be generated by oscillating negative charges in the form of negative magnetic potential by using negative electromagnetic oscillators in a negative potential domain as shown by FIG. 1 without sacrificing any positive potential from the DC source.

The main discovery of the patent is that the magnetic field of the electromagnetic potential and the electrical potential can be generated separately by two different positive DC sources using at least two distinct inductors electromagnetic oscillators which can generate both negative magnetic and electrical potential without depleting the positive charge of the DC source.

The scientific community, for some time now, has accepted and most scientifics today have reached the conclusion that negative electromagnetic potential (negative magnetic energy) is the primordial and fundamental common potential that moves the entire universe and makes the universe work, not just thru batteries but our own body and brain including all vegetation and life which surround us in the Universe operates using Negative potential.

Bottom line, Negative potential is the primordial element of energy that has always powered the Universe (including kinetic, heat and electromagnetic energy), as well as many other electromagnetic events which have been borrowed from attractive fields containing Negative potential while leaving behind lots of more new potential energy.

Negative energy, which is not very well known, is now seen as the answer to the old question of how the universe started and how it maintains itself powered.

Negative potential is the “universal primordial energy” of the formation and in charge of the maintenance of the Universe. Thus, justifying the saying that the Universe came from “Nothing.”

### Supporting Science

The behavior of an oscillating inductor characteristics within the 4^{th} quadrant curve negative domain reveals its operating properties.(See FIG. 1 shown below):
FIG. 1a Power-Current-voltage quadrant characteristics—(Courtesy of Wikipedia)

This patent is corroborated by the Current-voltage (FIG. 1a above) of the 4^{th} quadrant I-V domain which is a negative domain process where oscillating inductors and capacitors are converted into negative magnetic resistance properties devices by the high frequency oscillation, and this is the supporting science of the patent as to how to generate usable Negative electromagnetic potential.

Negative resistance devices occur in the 4^{th} quadrant as negative differential resistance devices which function as power sources which can produce electric power in the form of negative electromagnetic potential.

Negative resistance increases the relative density of electrons to the density of positive ions in a circuit per the laws of Special relativity and it inverts the relative direction of flow of the electrons which promotes an inverse relation between the current and the voltage of a circuit which for example, when current increases the voltage will degrease and vice versa. A negative resistor absorbs positive ions from its surroundings and converts it to electrical energy thus increasing the negative electromagnetic potential.

A negative differential resistance device, when operating in the 4^{th} quadrant negative domain, forces the current to flow through the device in a direction from the negative to the positive voltage terminal and against the opposing force of the electric field, so electrical charges are gaining negative potential energy thus converting the negative magnetic electrical potential into usable negative electromagnetic potential.

Usable negative electromagnetic potential is generated as per Lorentz forces law and as per the disclosed methods of this patent, by the perpendicular intersection of electromagnetic current and negative electromagnetic electrical potential vectors in the form of two negative electromagnetic oscillating vectors which intersect as shown electrically in (FIG. 2a),

Lorentz force is the force exerted on a charged particle q moving with velocity v through an electric field E vector and magnetic field B vector which intercept perpendicular to each other. The resulting electromagnetic force F on the charged particle is called the Lorentz force (after the Dutch physicist Hendrik A. Lorentz) and is given by.

F=qE+qv×B. formula (1)

Given the fact that electromagnetic potential forces(Lorentz forces) are produced only when both electrical and current charges are accelerated and given the fact that positive charges in a circuit are much harder to accelerate than negative charges, electromagnetic potential can be generated more efficiently by accelerating “negative charges” exclusively to produce electromagnetic potential as a result of cross-product vectorial electrical Lorentz forces created.

This patent uses at least two(2) electromagnetic oscillators in series as depicted in the electromagnetic electrical field generator shown as (FIG. 4) and the oscillating electromagnetic magnetic field generator shown as (FIG. 5) both generators within the negative domain of the 4^{th} quadrant of power generation (FIG. 1), and physically connected as shown in FIG. 6 circuit which will produce usable negative electromagnetic potential.

Negative electromagnetic potential occurs when an electromagnetic current, made out of negative charges, is forced to flow through the device from the negative to the positive voltage terminal, against the opposing electromagnetic force of the electric field produced by a negative differential potential formed by two different potential DC sources, so the composite electric circuit gains energy in the form of negative electromagnetic potential as useful negative electromagnetic potential to power electrical loads.

### Generic Inductors Notes

As per Lorentz and Laplace theories, an inductor when oscillated at high frequency becomes “a negative resistance device” which is conducive to the creation of useful negative electromagnetic potential in the 4^{th} quadrant negative domain as shown in FIG. 1.

Inductors operate in two distinct actuating phases; first phase occurs when the inductor ingests potential from the potential source storing energy in the inductor and forming a magnetic bubble and secondary phase when the inductor returns the stored bubble energy to the circuit as negative magnetic potential with reversed polarity. In this patent the inductors ingest negative electrical potential.

Initially in the first phase, the inductor is faced with a decreasing current, and subsequently in the second phase, the inductor acts as a potential source by creating and releasing potential with a reversed polarity, and it releases negative magnetic potential on the current entry side and positive on the current exit side.

An inductor when oscillating within the negative domain creates a negative resistance as an ideal inductor with zero resistance. The reactance of an oscillating ideal inductor, and therefore its impedance, is positive for all frequency and inductance values. The effective impedance (absolute value) of an inductor is dependent of the frequency of the oscillating circuit and for ideal inductors always increases with frequency. An Inductor, initially at t=0 is like an open circuit, correspondingly so it does not consume any energy from the source.

Initially a fully “discharged” inductor (no current through it) initially acts as an open circuit (voltage drop with no current) and when faced with the sudden application of voltage. the inductor acts as a short circuit (only current with no voltage drop).

The formula for the energy stored in a magnetic field is E=1/2 LI². The energy stored in a magnetic field is equal to the work needed to produce a current through the inductor. Electromagnetic energy is stored in the inductor's magnetic field.

This patent establishes as a statement of fact that negative electromagnetic potential can be produced by the composite electromagnetic oscillating circuit(s) inter-action of inter-acting active magnetic and electrical fields operating as vectors in the 4^{th} quadrant of the Current voltage within the differential negative domain which will promote the generation of usable negative electromagnetic potential without the sacrificing or depleting of the potential charges of the DC sources.

### MAIN DISCLOSURE OF THE PATENT

Electrical potential relates to the acceleration of electromagnetic charges which produces usable cross-product Lorentz electromagnetic forces to create electromagnetic potential; very distinctly, positive charges in the “electrical field” (positive ions) are extremely harder to accelerate than negative charges(electrons) in the “magnetic field.”

This patent uses two negative electromagnetic oscillators working in series in the negative 4^{th} quadrant of power generation(FIG. 1) to generate negative electromagnetic without depleting the positive potential of the DC source.

A main part of the discovery of this patent is the relationship produced by the composite negative electromagnetic oscillating circuit(s) powered by positive potential which produce negative electromagnetic electrical and negative magnetic electromagnetic charges which interacts vectorially with the magnetic and electrical fields(operating as vectors) to produce Lorentz Forces in the 4^{th} quadrant of the electrical power cycle to produce usable electromagnetic potential to drive electrical loads without discharging the DC sources.

As predicted by Dirac theories, we can obtain as much Negative potential as we wish from the environment which acts as a boundless magnetic source. This patent presents a method to extract “negative electromagnetic potential energy” from the “ether” as described by Dirac theories.

The two electromagnetic oscillators are powered independently by separate DC sources, the “magnetic field oscillator” is powered by a single larger DC source while the “negative electrical field oscillator” is powered by a differential negative potential created by both the larger battery and the smaller dissimilar size batteries(as shown in FIG. 6) creating a negative differential potential, thus procuring as much electromagnetic potential as we wish to have without destroying the source's positive charges and without breaking the Second Law of Thermodynamics.

Numerous working models of this patent have been constructed in real-time which proves that “usable electromagnetic potential” from oscillating inductors can be obtained to drive electrical loads without discharges the DC sources.

### Previous Art

The previous art is represented by U.S. Pat. No. 6,362,718 Patrick et al. The previous art deals with the much-desired properties of generating positive potential from DC sources, however, fails to disclose any claim and fails to recognize the utilization of negative magnetic potential properties of a method to protect the destruction of the positive charge of its sources and fails to mention the need to operate as a negative magnetic device within the negative potential differential negative domain.

### New Art Method to Generate Negative Electromagnetic Potential Using Oscillating Inductors.

The NEW ART refers to a new motionless method of harvesting usable negative electromagnetic potential from electrical DC sources by oscillating inductors devices at high frequencies within a negative differential potential electrical field within the negative domain and mixing it with negative magnetic current produced by inductor oscillator circuits which produces magnetic and electrical field vectors which intersects perpendicular to each other as per Lorentz Law of Force laws which ultimately generates usable negative electromagnetic potential without sacrificing the positive charge of its DC sources.

The patent uses inductors which when oscillated at high frequency become “negative resistance devices” and which promote the production of usable negative electromagnetic magnetic potential.

The generated Negative electromagnetic potential is converted to useful potential which can be utilized to power electrical loads such as lights, homes. move motors, computers and generic electrical loads.

This patent presents a motionless method and an apparatus to utilize regular DC batteries potential and utilize its charge while negating the destruction of its charge by the using of two dissimilar size batteries(which creates a negative electrical potential differential) and by using at least two oscillating inductors circuits, which oscillate the negative electrical differential and oscillate the current of the batteries as shown FIG. 6.

### BACKGROUND OF THE INVENTION

Our society depends on electrical energy increasingly every day from oil fueled generators, today most of the electrical energy is generated by magnetic generators which are rotated at high RPM by forces derived from carbon fuels thus creating hydro-carbon pollution as well as heat pollution.

Today most of the electrical energy used is produced by accelerating charged particles such as ions or electrons doing electrical work as fueled by oil. The electrical energy which is generated commercially today is mostly made from “positive electrical charged particles” which are sacrificed when doing positive work against a “common ground” thus discharging the source.

The electrical energy that we know today is made from accelerating positive charged particles in the form of positive potential.

Unbeknown today to most people accept that energy must be spent, today our electrical circuits methods are sacrificing the electrical potential stored in the electrical positive sources without the need of being so.

As described by Lorentz Forces Law, electrical energy is just another word for electro-magnetic forces which are generated by electrical and magnetic fields forces acting on each other in a perpendicular vector intersection. The Lorentz force law states that a magnetic field exerts a force on a moving ionic current.

Positive potential as we know it is made of accelerating positive charged particles(ions) moving from a positive to a negative potential plateau with a clockwise rotating magnetic field. Most of the electrical devices in our society use Positive potential.

Positive magnetic potential (see FIG. 3a) inherently carries a self-destructive feature that when used it consumes itself which destroys the potential charge of the battery.

On the other hand, Negative electromagnetic potential (see FIG. 3b), not very well known, is made out of accelerating charged particles traveling from a negative to a positive potential plateau creating an anti-clockwise magnetic field.

While Positive potential is very usable because it generates physical forces which moves “moves electrical motors and others,” Negative magnetic potential exist and its function is subtle in nature but extremely hard to detect and it can only when stored in batteries or supercapacitors.

By its very nature, Negative magnetic potential is not self-destructive, and once generated, it can be converted and augmented into Positive magnetic potential.

Our entire world today is powered by positive potential doing positive work which depletes the DC sources charge. Today our circuits use “positive potential” to do electrical work. This practice discharges the “positive potential” thus depleting the source.

As a general practice, our conventional batteries and electrical sources are designed to store positive potential and negative potential in two separate compartments.

For two centuries or more, we have accepted this “discharging idea” (of Positive potential) easily as normal, no question asked. We use the electrical sources until discharged and then we charge them again.

This patent is about a method to utilize electrical energy without consumption by utilizing Negative energy to power electrical loads.

This patent brings forward the idea of utilizing Negative magnetic potential (See FIG. 3b) to do negative work instead of using Positive potential which self-depletes.

Our conventional battery apparatus technically primarily today is made out and are two parts working together, one-part stores positive potential as an electrical field charge and the other part stores negative potential as a Magnetic field charge(electrical current) which is only active when the electrons move. The acceleration of the “negative field” charges is easier than the acceleration of ions of the “electrical field” charges.

This patent brings to the forefront, a motionless electromagnetic generator device uses primarily a Negative electromagnetic potential system which is dynamic in nature which does not discharge its sources:
(a) The NEW ART as presented is a composite negative electromagnetic potential harvesting battery system which is dynamic in nature which operates within the negative domain of the 4^{th} quadrant of electrical power(FIG. 1) and which does not destroy the positive charge of the batteries.
(b) The NEW ART as presented is a composite method which uses at least two electromagnetics oscillators which extract “negative electromagnetic potential” from two different DC sources in a motionless fashion thru the oscillating of at least two electromagnetic oscillator circuits(See FIGS. 4 and 5) which produces negative electromagnetic potential which does not discharge the source.
(c) The NEW ART as proposed is negative magnetic potential harvesting battery system which generates Negative magnetic potential which uses two dissimilar size DC sources as shown in FIG. 6 to create a negative magnetic potential differential negative domain.
(d) The NEW ART as proposed is a composite apparatus can be used to convert electrical energy in the form of DC or AC (like commercial electrical energy) or electrical energy from DC sources into Negative magnetic energy which does not produce heat thus eliminating the “global warming effect.”
(e) But most important, the harvested potential does not produce harmful heat-pollution because it does not utilize Positive potential which is the main culprit heat-pollution maker for working electrical applications.
(f) The NEW ART in a way recycles the electromagnetic potential.
(g) The Negative potential harvesting device cannot discharge the Positive potential portion of the source because it does not use the Positive potential of the sources.

This patent relates to a motionless novice method and apparatus to generate and negative magnetic potential to produce usable Positive energy potential which does destroy the charge of the batteries.

### BRIEF SUMMARY OF THE INVENTION

### According to this Patent

(a) This patent describes a method to build a negative electromagnetic motionless generator which generates electrical potential in the form of Negative electromagnetic potential produced from DC sources without destroying the batteries electrical charge.
(b) This patent demonstrates that oscillating of inductors in a differential negative electrical environment of the 4^{th} quadrant of the Voltage-current power(FIG. 1) convert inductors into “negative resistance devices.”
(c) The apparatus is made of at least two electromagnetic oscillators circuits in series (as high frequency RLC circuits) which operate in the negative domain which is made of at least one electrical field oscillator circuit (FIG. 4) and at least one magnetic field oscillator circuit(FIG. 5) which are powered by dissimilar size batteries. The larger battery acts a capacitor which stores negative energy in its E-field, and several oscillating inductors store negative magnetic energy in its B-field. This periodic oscillating exchange of negative energy constitutes a negative electromagnetic oscillator which produces a vectorial Lorentz forces cross-product which create useful electromagnetic potential.
(d) Negative magnetic potential can be used to do useful work without producing heat.
(e) Negative magnetic potential can be converted to positive potential thru rectification.

### BRIEF DESCRIPTION OF THE DRAWINGS

The drawings illustrate preferred embodiment of the methods and devices of the discovery and the reference numbers in the drawings are used consistently throughout, as follows:

FIG. 1—Negative resistance power production 4^{th} quadrant resistance.

FIG. 2—NEW ART High frequency negative resistance oscillating process

FIG. 2a—NEW ART 4^{th} quadrant negative potential electromagnetic generator.

FIG. 3a—Positive magnetic potential.

FIG. 3b—Negative magnetic potential.

FIG. 4—NEW ART Negative electromagnetic electrical potential generator circuit.

FIG. 5—NEW ART Negative electromagnetic current potential generator circuit.

FIG. 6—NEW ART Motionless non-destructive negative electromagnetic potential generator.

FIG. 7—Generic method to increase the negative potential generating capacity by adding multiple current and multiple satellite negative differential electrical oscillators.

### DETAILED DESCRIPTION OF THE INVENTION PREFERRED EMBODIMENTS

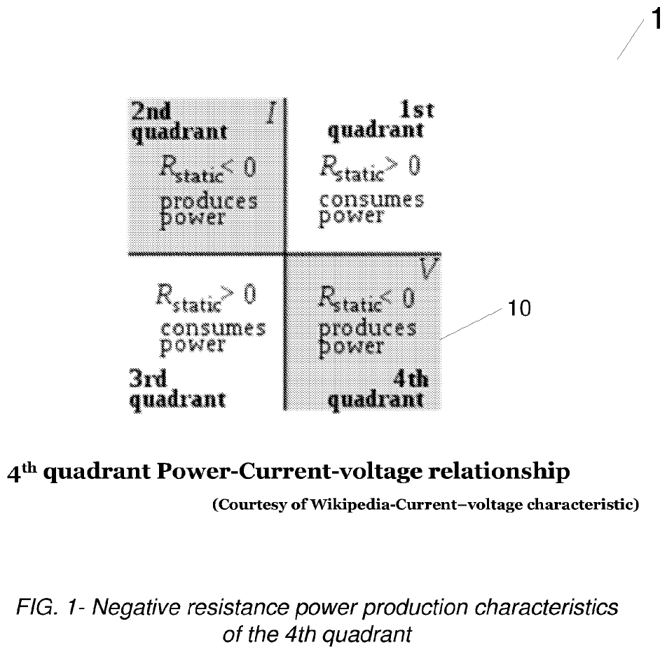

FIG. 1 represents a graphical representation of the electrical power production/consumption quadrants relationship (as courtesy of Wikipedia) and it shows the electrical power quadrant relationship of electrical power to current and voltage which is particularly applicable for the patent being documented.

The representation is a graphical relationship of the behavior of electrical power as related to electrical current and voltage changes, of particular interest and pertaining to this patent, the 4th Quadrant which refer to the production of production and consumption of electrical potential. Negative electromagnetic potential can be produced by the high frequency oscillating of inductor devices which turns a receiving inductor into a “negative differential resistance device.”

The representation shows that electrical inductor devices which operate within the I-V curves which operate within the fourth quadrants within the negative domain can be used as power sources and which can produce electric power.

When an electrical device such as an inductor is operating in the fourth quadrant negative domain, the current is forced to flow through the device from the negative to the positive voltage terminal, against the opposing force of the electric field, so the electrical charges are gaining potential energy, this potential is negative in nature. Thus, the electrical device is converting electrical energy into Negative electromagnetic potential, this conversion must take place within a negative electrical potential differential condition.

Oscillating inductors which operate within the I-V curves of which pass through the fourth quadrant and thus becomes a Negative resistance device and therefore generate electrical power.

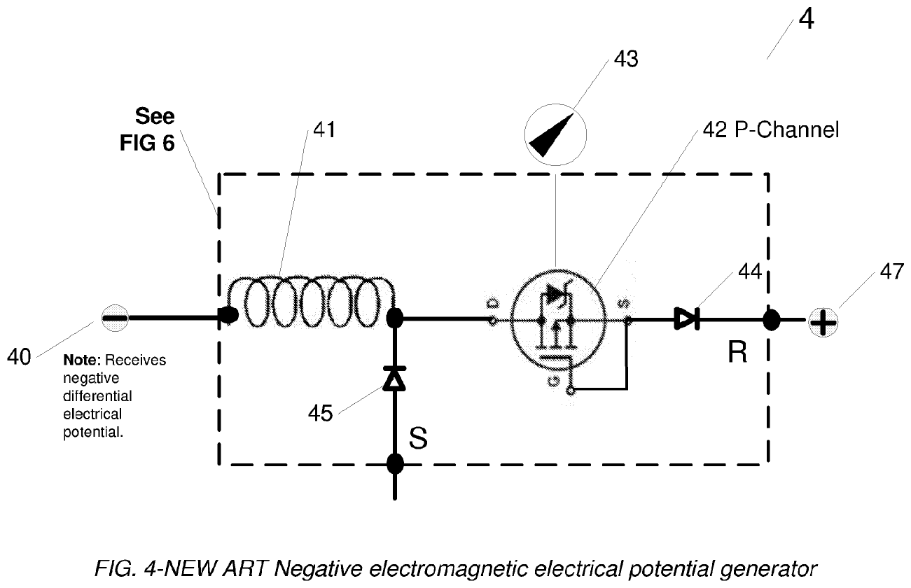

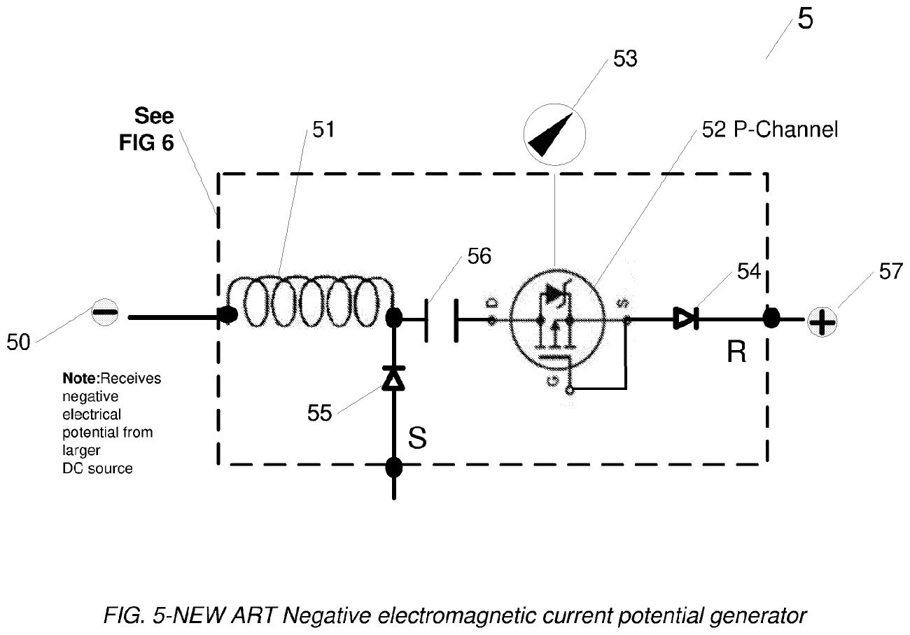

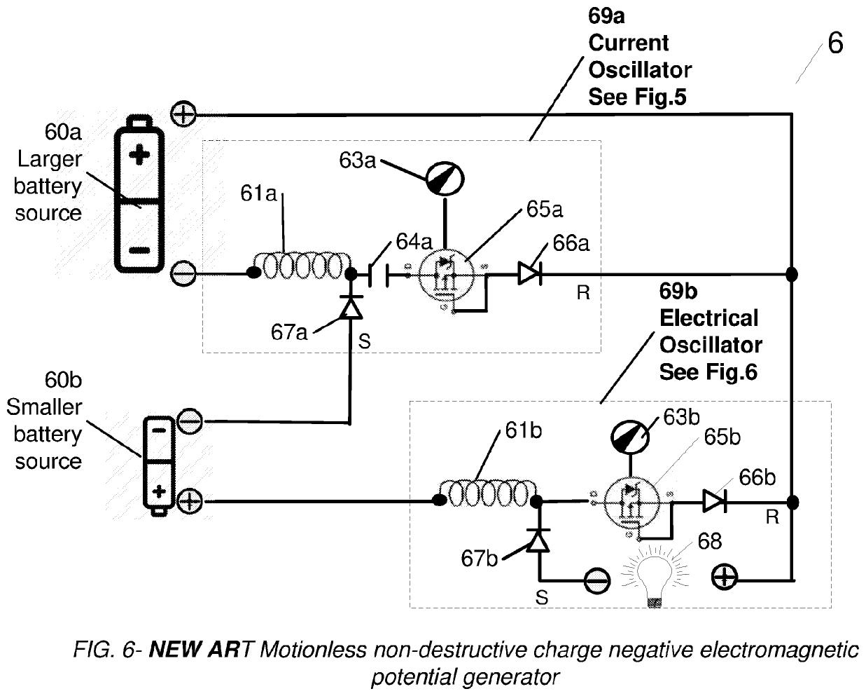

An oscillating inductor when it is operating in the fourth quadrant, current is forced to flow through the device from the negative to the positive voltage terminal, against the opposing force of the electric field, so the electric charges in a circuit gain potential energy as shown in (FIGS. 4 and 5).

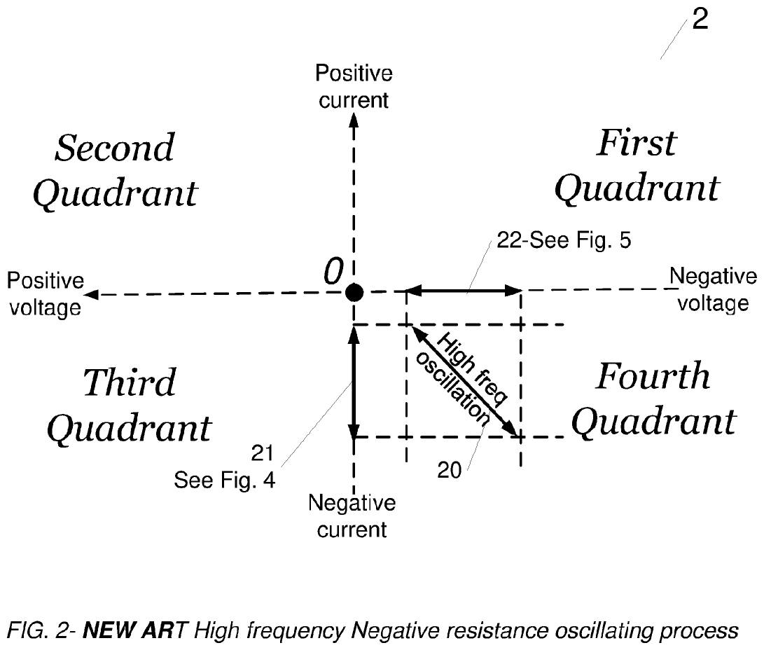

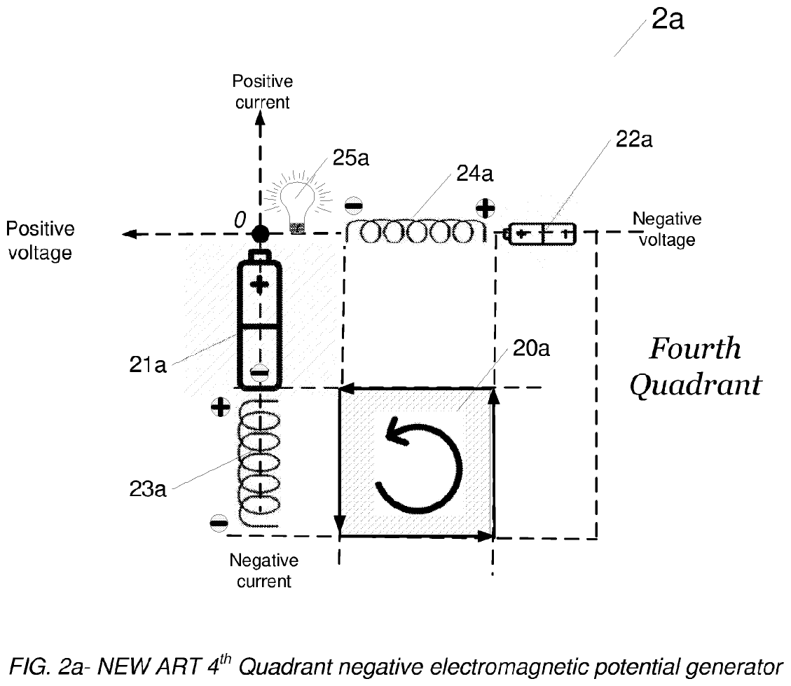

NEW ART FIG. 2 is a representation of System 2 of the high frequency oscillation negative resistance electromagnetic process(20) which occurs in the 4^{th} quadrant of the power within the negative domain (FIG. 1) where negative electromagnetic current potential forces (21) and where negative electromagnetic electrical potential forces (20) are developed and which merge in a fashion perpendicular to each other (as per Lorentz forces law) to produce an overall aggregate of resultant electromagnetic net forces which produces useful negative electromagnetic potential.

The electromagnetic process(20) requires at least one negative electromagnetic current generator (21) and at least one negative electromagnetic electrical potential generator(22) to produce negative electromagnetic potential without affecting or destroying the positive charge of the battery source.

NEW ART FIG. 2a represents System 2a the 4^{th} quadrant negative potential electro-magnetic generator which is a representation of the resultant negative electromagnetic cycle generated(20a) by the negative electromagnetic current forces and the negative electromagnetic electrical potential forces.

System 2a includes at least one large DC source(21a), at least one smaller DC source(22a), at least one oscillating negative electromagnetic current generator(23a) and at least one oscillating negative electromagnetic negative electrical potential generator(24a).

The cross-product vectorial aggregation of negative electromagnetic forces (20a) produced by the negative electromagnetic current oscillator(23a) and negative electromagnetic electrical oscillator(24a) produces a counter-clock rotating electromagnetic forces output which produces useful negative electromagnetic potential(25a).

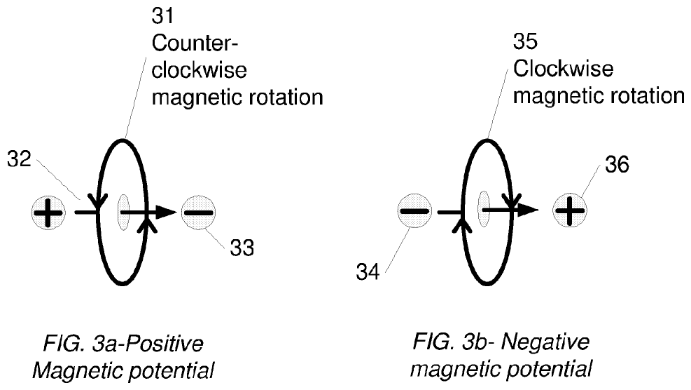

FIG. 3a is a representation of the Positive electromagnetic potential containing an electrical field where Positive potential(3a) goes from Positive(32) to Negative(33) and where the magnetic field(31) rotates CW (clockwise). Positive magnetic potential is generic to the positive side of DC sources.

FIG. 3b is a representation of the Negative electromagnetic potential containing a magnetic field where Negative potential(3b) goes from Negative(35) to Positive(36) and where the Magnetic field(34) rotates CCW(counterclockwise). Negative magnetic potential is generic to the negative side of DC sources. Negative electromagnetic potential can be produced by the high frequency oscillation of inductors (during the relaxation phase) when powered by a negative differential electrical potential provided by the differential of two DC sources.

NEW ART FIG. 4 as shown as System 4 represents the non-destructive charge negative electromagnetic electrical potential generator which converts the differential electrical energy into Negative electromagnetic electrical potential. The Non-destructive charge electrical conversion oscillator circuit is made of an inductor device(41), which is self-sustaining and self-oscillated by a P-Channel Mosfet-transistor (42) which acts as a high frequency self-acting switch which oscillates at a high frequency or optionally exteriorly by a Frequency controller(43) which can be modulated.

Oscillation of the inductor(41) at high frequency converts the inductor(41) into a “negative resistance device” which increases the electrical negative magnetic potential of the system as shown in FIG. 3a. Diodes(44) and (44) provide routing to the negative magnetic potential produced by the module. System 4 is powered by a negative differential electrical potential source created by dissimilar battery sources which will be detailed in FIG. 6.

NEW ART FIG. 5 as shown as System 5 represents the Non-destructive charge negative electromagnetic current generator which converts the negative electromagnetic potential into Negative electromagnetic current potential.

The Non-destructive charge current charge oscillator circuit is made of an inductor device(51), which is self-sustained and self-oscillated by a P-Channel Mosfet-transistor (52) which acts as a high frequency self-acting switch and which oscillates at a high frequency and which can be modulated by Frequency controller(53) exteriorly (optional) and a capacitor(56).

Oscillation of the inductor(51) at high frequency converts the inductor(51) into a “negative resistance device” which increases the electrical negative magnetic potential of the system as shown in FIG. 3b. Diodes(54) and (55) provide routing to the negative electromagnetic potential produced by the module.

NEW ART FIG. 6 Motionless non-destructive charge negative electromagnetic potential generator(6) as shown as System 6 represents the “apparatus” needed to extract magnetic potential from battery sources without destroying the batteries charge. System(6) merges vectorially the Negative electromagnetic current potential vector and the Negative electromagnetic electrical potential vector to produce the usable Negative electromagnetic potential which can be used to drive electrical loads.

The Motionless non-destructive negative magnetic potential generator(6) is made out of at least two dissimilar size battery sources, shown as at least one Larger battery source(60a) and at least one Smaller battery source(60b) which are positioned in an opposing position and connected to inductor(61a) via common Inductor(61a) to create a negative differential electrical potential which uses at least one current charge oscillator circuit(69a) See FIG. 5 and at least one positive potential charge oscillator circuit(69b) See FIG. 4.

Output(68) is connected positively to the positive terminal of Source(60a) and connected negatively to the terminal point S of the electrical potential charge oscillator circuit(69b) See FIG. 4.

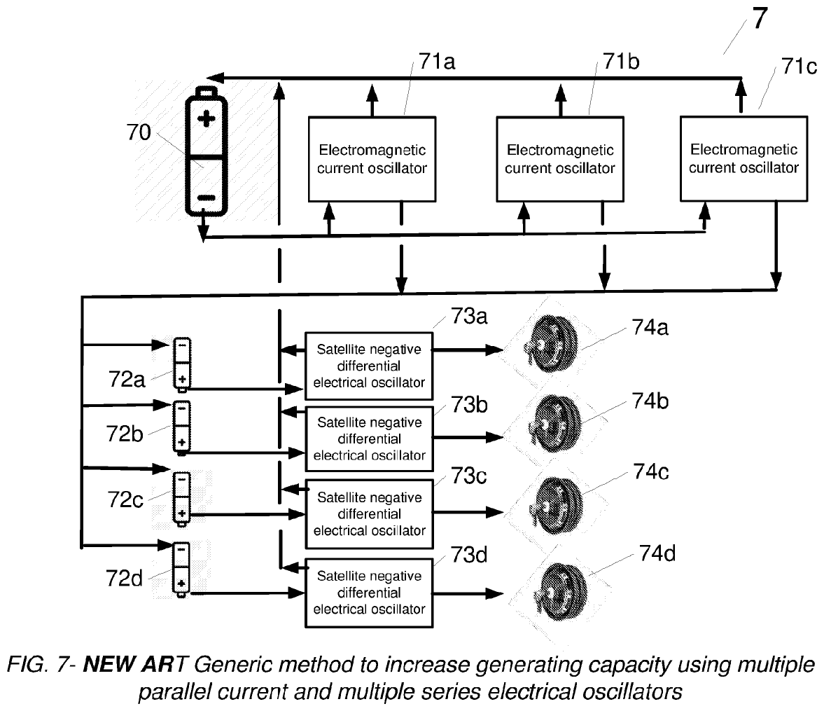

FIG. 7—NEW ART is a generic method to expand the negative electromagnetic potential generating capacity by adding multiple electromagnetic current generators in parallel as well as adding multiple satellite negative differential electrical generators in series.

The capacity can also be controlled by the controlling the oscillation frequency of the electromagnetic oscillators.

FIG. 7 is a possible application for a vehicle where each axle gets electromagnetic potential.

### Invention is Useful, Demonstrable and Fully Operational

The inventor has built several working prototypes and has in his possession several fully functional and operational protypes; therefore, the invention is available and demonstrable and operative and therefore does not lack utility. The patent has usability as it can be used in industry and home and it be used in transportation and many more uses.

### TECHNICAL FIELD

This patent relates to the methods and devices of harvesting Negative electromagnetic potential from DC sources. Fundamentally the patent deals with the production, recovery and utilization of Negative electromagnetic potential extracted without discharging the electrical DC source.

### Problem being Addressed

There is a need for a clean, non-polluting, re-usable potential source which is recyclable, clean and easily usable as an electromagnetic fuel which is compatible with our electrical power applications which is recoverable which is portable and scalable in nature without producing pollution to the environment. The primarily problem being addressed is the present waste of fuels and potential to produce electrical energy by our present electrical systems which shunts the source at the onset and destroys the potential of DC energy sources. Negative electromagnetic potential is the answer.

(End of specifications)

What is claimed:

1. A high frequency motionless electromagnetic apparatus which operates within the negative electrical domain of the 4^{th} quadrant for Electrical power production which uses at least two separate DC sources and at least two separate negative electromagnetic oscillators to generate the magnetic field and the electrical field separately which produces a resultant Lorentz vectorial forces cross-product which extracts electromagnetic potential from DC batteries without destroying the battery's charge by using at least one negative electromagnetic electrical potential oscillator circuit and at least one electromagnetic current potential oscillator circuit each controlled by its own high frequency electronic switching oscillator circuits which converts inductor devices into “negative differential resistance devices” forming and merging as a Lorentz force composite cross-product vector made out of negative electromagnetic currents and negative electromagnetic electrical potential powered by a differential electrical potential produced by at least one larger battery source and at least one smaller battery to power electrical loads within the 4^{th} quadrant of electrical power production negative domain as usable negative electromagnetic potential without consuming the positive charge of the battery sources.

2. A high frequency motionless electromagnetic method which operates within the negative electrical domain of the 4^{th} quadrant for Electrical power production which uses at least two separate DC sources and at least two separate negative electromagnetic oscillators to generate the magnetic field and the electrical field separately which produces a resultant Lorentz vectorial forces cross-product which extracts electromagnetic potential from DC batteries without destroying the battery's charge by using at least one negative electromagnetic electrical potential oscillator circuit and at least one electromagnetic current potential oscillator circuit each controlled by its own high frequency electronic switching oscillator circuits which converts inductor devices into “negative differential resistance devices” forming and merging as a Lorentz force composite cross-product vector made out of negative electromagnetic currents and negative electromagnetic electrical potential powered by a differential electrical potential produced by at least one larger battery source and at least one smaller battery to power electrical loads within the 4^{th} quadrant of electrical power production negative domain as usable negative electromagnetic potential without consuming the positive charge of the battery sources.

3. The counter-rotating negative electromagnetic oscillators process using high frequency electromagnetic generators (RLC circuits) which are composed of at least two electromagnetic oscillators inductors circuits powered by at least two separate DC sources which develop electromagnetic currents and electrical potential forces in the form of negative Lorentz and Laplace electromagnetic vector cross-product forces operating within the 4^{th} quadrant of the electrical power negative domain forming continuous counter-clockwise rotation of negative electromagnetic vector forces developed by negative electromagnetic potential which can be used to drive electrical loads without consuming the positive potential by the simultaneously aggregation of the vector effect forces developed by negative electromagnetic magnetic currents and electrical positive potential vectors which intersect perpendicularly to each other developing Lorentz vectorial forces within the negative domain of the 4^{th} Quadrant which produces negative electromagnetic potential which can be used as fuel to drive electrical loads without consuming or discharging the DC sources charge.

4. The motionless method of claim 1 to aggregate and harvest Negative magnetic potential produced by high frequency oscillating inductors which converts inductors into negative resistance devices which invokes negative differential resistance properties and which produces negative electromagnetic potential which can be used to drive electrical loads while avoiding and blocking the direct use of positive potential from the DC sources thus eliminating their discharging.

5. The method of claim 3 of generating usable negative electromagnetic potential by using the negative potential and the differential potential of at least two different DC sources to produce usable negative electromagnetic potential.

6. The method of claim 1 of converting electrical positive energy into useful Negative electromagnetic potential which replaces the use of positive potential which powers mobile and non-mobile loads such as homes, automobiles, trains, airplanes and generic buildings and other loads which does not deplete the battery sources.

7. The method of claim 1 of utilizing negative electromagnetic potential in lieu of positive potential from DC sources to power electrical loads. (End of claims)
